(19) United States
(12) Patent Application Publication
(10) Pub. No.: US 2003/0178736 A1
(43) Pub. Date: Sep. 25, 2003

(54) Method for manufacturing naturally-degraded disposable dish, and apparatus therefor

(76) Inventor: Ki-Ok Hwang, Changwon-si (KR)

Correspondence Address: DICKINSON WRIGHT PLLC, Suite 800, 1901 L Street, N.W., Washington, DC, 20036, US

(21) Appl. No.: 10/279,911

(22) Filed: Dec. 13, 2002

(30) Foreign Application Priority Data
Mar. 20, 2002 (KR) 2002-0014905

(51) Int. Cl. B29C 35/12

(52) U.S. Cl. 264/85; 425/144; 264/319

(57) ABSTRACT

The present invention discloses a method for manufacturing a naturally-degraded disposabtle dish comprising: a first step for stirring 17.4 wt % of rice straw power, 4.3 wt % of rice bran powder, 61 wt % of coating agent and 17.3 wt % of corn starch to be uniformly mixed; a second step for forming a dish by compressing the mixture; and a third step for sterilizing the dish with an ozone gas. Also, the present invention discloses an apparatus for manufacturing a naturally-degraded disposable dish comprising: an upper mold having a die where electric heating lines are filled; a lower mold having a space unit for receiving the upper mold and a die where electric heating lines are filled; a controller for adjusting a temperature of the upper/lower molds by controlling electric power transmitted to the electric heating lines; and a transfer means for automatically extracting a formation object from the upper/lower molds, and automatically stacking the formation object. As discussed earlier, the present invention enhances strength of the dish by using the rice bran powder and corn starch, simplifies the manufacturing process and reduces the manufacturing time by mixing the raw formation materials at a time, and thus remarkably cuts down the manufacturing expenses.

### BACKGROUND OF THE INVENTION

1. Field of the Invention

The present invention relates to a method for manufacturing a naturally-degraded disposable dish and an apparatus therefor, and in particular to a method for manufacturing a naturally-degraded disposable dish and an apparatus therefor which can enhance strength of the disposable dish, reduce a manufacturing time due to a simple manufacturing process, simplify a metal mold for manufacturing the dish, and automatically stack the dishes.

2. Description of the Background Art

According to the complication of society and the improvement of life, orders or outdoor activities have been increased to raise the demand for disposable dishes.

When the disposable dish composed of a plastic material such as polypropylene is abolished by burning, it generates poisonous substances to worsen pollution. In the case that the disposable dish is wasted in the ground, it is not degraded to cause the environmental pollution.

Thus, the applicant concerned filed an application for ‘a method for manufacturing naturally-degraded disposable dish and an apparatus therefor’ on May 17, 2001 (application No. 10-2001-26889).

In Example 1, the manufacturing method includes the steps of: mixing 78 to 95 wt % of rice straw powder, 4 to 17 wt % of rice flour and 1 to 5 wt % of maltose; first-sterilizing the resulting mixture of the rice straw powder, rice flour and maltose at a temperature below 90 to 130° C. for 30 to 90 minutes; forming a dish by compressing the sterilized mixture; coating a bran wax on the dish, and drying the dish; and second-sterilizing the dish at a temperature ranging from 90 to 120° C. for 30 to 60 minutes, and drying the sterilized dish. In Example 2, the manufacturing method includes the steps of: stirring 1 to 5 wt % of maltose and 20 to 30 wt % of water, and fumigating the resulting mixture at a temperature ranging from 90 to 130° C.; adding 4 to 19 wt % of rice flour to the maltose containing water, stirring the resulting mixture, adding 50 to 75 wt % of rice straw powder to the stirred mixture, and stirring the resulting mixture; forming a formation object by compressing the mixture containing the maltose, rice flour and rice straw powder; drying the formation object; coating a coating agent on the dried formation object, and drying the coated formation object; and sterilizing the formation object coated with a bran wax.

In addition, the manufacturing apparatus includes: an upper mold; a lower mold having a space unit for receiving the upper mold, a hole being formed on the bottom of the space unit; and an inner mold having a plate-shaped upper portion, and being installed in the space unit of the lower mold to be moved in the upward/downward direction, a push stick having an air injection hole through which air flows being formed below the plate-shaped upper portion. Here, the manufacturing apparatus manufactures a dish according to the steps of: positioning the plate-shaped inner mold on the bottom of the space unit of the lower mold; injecting raw formation materials into the space unit of the lower mold; forming the raw formation materials in a dish shape by pressing the upper mold toward the space unit of the lower mold and compressing the raw formation materials of the space unit; removing a pressure of the upper mold, and lifting the upper mold; lifting the inner mold from the bottom of the space unit in order to separate the formation object from the lower mold; and injecting the air into the air injection hole of the inner mold in order to separate the formation object from the inner mold.

However, the method and apparatus for manufacturing the dish have the following disadvantages:

In the case of the manufacturing method, the dish is manufactured according to the steps of mixing-first sterilization-dish formation-second sterilization and drying in Example 1, and manufactured according to the steps of fumigation-first stirring-second stirring-mixture formation-first drying-coating and second drying-sterilization in Example 2. Here, the manufacturing process is complicated due to special sterilization, drying and coating steps, thereby increasing the manufacturing time.

In the manufacturing apparatus, when the air is injected through the air injection hole formed in the push stick by using the upper/lower molds and the inner mold (having the push stick and air injection hole), the dish is separated from the surface of the inner mold. Accordingly, the non-hardened dish can be separated from the inner mold without deformation. However, the inner mold is required to separate the non-hardened dish from the mold without deforming the dish, which complicates a structure of the apparatus. In addition, an operator should pick up the separated dish and stack it on a proper position. That is, the mold is complicated and the operator is needed.

Moreover, the rice flour and maltose are used in Examples 1 and 2. The dish is easily broken due to the rice flour, and the maltose is expensive to increase manufacturing expenses.

### SUMMARY OF THE INVENTION

Accordingly, it is a primary object of the present invention to provide a method for manufacturing a naturally-degraded disposable dish and an apparatus therefor which can enhance strength of the naturally-degraded disposable dish, reduce a manufacturing time by simplifying the manufacturing process, and cut down manufacturing expenses.

Another object of the present invention is to provide a method for manufacturing a naturally-degraded disposable dish and an apparatus therefor which can cut down the prime cost by simplifying a structure of the apparatus, and automatically stack the disposable dish extracted from the apparatus.

In order to achieve the above-described objects of the invention, there is provided a method for manufacturing a naturally-degraded disposable dish including: a first step for stirring 17.4 wt % of rice straw power, 4.3 wt % of rice bran powder, 61 wt % of coating agent and 17.3 wt % of corn starch to be uniformly mixed; a second step for forming a dish by compressing the mixture; and a third step for sterilizing the dish with an ozone gas.

The second step includes: a step for forming the mixture for 9 to 10 seconds by first compression, evaporating bubbles of the dish for 2 to 4 seconds, and forming the dish for 42 to 47 seconds by second compression.

Preferably, the method for manufacturing the naturally-degraded disposable dish uses 25 wt % of rice straw power, 5 wt % of rice bran powder, 20 wt % of coating agent and 50 wt % of corn starch, forms the mixture for 10 to 15 seconds by first compression, evaporates bubbles of the dish for 2 seconds, and forms the dish for 25 to 30 seconds by second compression.

In addition, a method for manufacturing a naturally-degraded disposable dish Which injects raw formation materials into a space unit of a lower mold, forms the raw formation materials of the space unit in a dish shape by pressing an upper mold toward the space unit of the lower mold and compressing the raw formation materials, removes a pressure of the upper mold and lifts the upper mold, includes the steps of: automatically separating the dish from the lower mold and lifting the dish by vacuum adsorption; and transferring and automatically stacking the dish.

An apparatus for manufacturing a naturally-degraded disposable dish includes: an upper mold having a die where electric heating lines are filled; a lower mold having a space unit for receiving the upper mold and a die where electric heating lines are filled; a controller for adjusting a temperature of the upper/lower molds by controlling electric power transmitted to the electric heating lines; and a transfer means for automatically extracting a formation object from the upper/lower molds, and automatically stacking the formation object.

The transfer means of the apparatus for manufacturing the naturally-degraded d posable dish includes: a holder moved in a forward/backward direction and lifted by the controller; and a cylinder installed in the holder for lifting a vacuum adsorbing plate for vacuum-adsorbing the formation object.

### BRIEF DESCRIPTION OF THE DRAWINGS

The present invention will become better understood with reference to the accompanying drawings which are given only by way of illustration and thus are not limitative of the present invention, wherein:

FIG. 1 is a structure view illustrating an apparatus for manufacturing a naturally-degraded disposable dish in accordance with the present invention; and

FIG. 2 is a view illustrating an extraction process by a transfer means in accordance with the present invention, wherein:

FIG. 2a is a view illustrating a state where a vacuum adsorbing plate is closely fixed to a dish so that the transfer means can lift the dish; and

FIG. 2b is a view illustrating a state where the dish is extracted from a lower mold by the transfer means.

### DETAILED DESCRIPTION OF THE PREFERRED EMBODIMENTS

A method for manufacturing a naturally-degraded disposable dish and an apparatus therefor in accordance with preferred embodiments off he present invention will now be described in detail with reference to the accompanying drawings.

### Example 1

Example 1 shows a disposable instant noodle dish which is naturally degraded within 6 months.

Firstly, 17.4 wt % of rice straw power, 4.3 wt % of rice bran powder, 61 wt % of coating agent and 17.3 wt % of corn starch are stirred to be uniformly mixed.

In order to form the dish by compressing the mixture, the uniformly-mixed mixture which comprises raw formation materials is formed for 9 to 10 seconds by first compression, and bubbles of the dish are evaporated for 2 to 4 seconds.

Then, the dish is formed for 42 to 47 seconds by second compression.

The dish is manufactured at a temperature ranging from 135 to 145° C., and thus naturally dried and basically sterilized.

Finally, the dish is sterilized by using an ozone gas.

### Example 2

Example 2 shows a disposable lunch dish which is naturally degraded within 48 hours.

Firstly, 25 wt % of rice straw power, 5 wt % of rice bran powder, 20 wt % of coating agent and 50 wt % of corn starch are stirred to be uniformly mixed.

In order to form the dish by compressing the mixture, the uniformly-mixed mixture which comprises raw formation materials is formed for 10 to 15 seconds by first compression, and bubbles of the dish are evaporated for 2 seconds.

Then, the dish is formed for 25 to 30 seconds by second compression.

The dish is manufactured, at a temperature ranging from 135 to 145° C., and thus naturally dried and basically sterilized.

Finally, the dish is sterilized by using an ozone gas.

The difference in the degrading time between Example 1 (6 months) and Example 2 (48 hours) results from a mixing ratio and compression formation time.

That is, the degrading time is dependent upon the mixing ratio and compression time in all kinds of goods such as disposable instant noodle dishes, disposable lunch dishes, cola cups, seedling cups and chopsticks.

In Examples 1 and 2, as identical to the rice straw powder, the rice bran powder is solidified to harden the dish, rapidly naturally degraded and easily purchased. In addition, the dish can be ran as feed of livestock. Differently from rice flour, the rice bran powder shows the optimal strength in the compression formation, to manufacture the strong dish.

Identically to maltose, the corn starch is easily dissolved in water to increase a degrading speed of the dish, and compensates for crumble elements of the rice straw to manufacture the strong dish. Moreover, the corn starch is much cheaper than maltose.

As described above, the dish is finally sterilized by using the ozone gas. In general, ozone is an instable gas which has high chemical activity. The ozone attacks bacteria or viruses in the air or water, fungi, a various kinds of noxious gases generating a bad smell, and harmful organic substances such as solvents, agricultural chemicals and heavy metals, and oxidizes them due to chemical reactions. Although the ozone has a sterilizing power faster than chlorine by a few hundred times and stronger in the water than a general chlorine group sterilizer by seven times, it is an organic substance which does not have persistency. The residual ozone gas is gradually completely dissolved into oxygen, and thus is not harmful at all.

Moreover, the coating agent is totally different from the general PB-03 bran wax coating agent, comprises armino acid, benzoic acid and estradiol, and prepared at Fuzhou district of Fujian in China, which its name of manufactured goods is ‘Angimosobun’. Non-toxicity of the coating agent has been verified by an experiment of the Fujian sanitation and infectious disease prevention section using mice.

### Toxicity Experiment

On the basis of application technologies for supplying snack dishes to the office of Railroads, 60 ml of distilled water, 4% of acetic acid, 65% of ethyl alcohol and 65% of ethane are uniformly mixed, and concentrated by 70 to 75% by using an evaporator, to obtain 20.0 ml of solution. 4.0 g of corn starch is added thereto. The resultant solution is heated to a gruel state.

On the other hand, 18 to 22g of young Kunming (China) mice are selected and divided into a control group and a test group. Each group has 10 male mice and 10 female mice.

In the control group and the test group, the gruel-state sample liquid and coating agent are injected into stomachs of the mice by 0.33 mg/l by weight.

No mouse is died after one week.

The compression formation of the dish can be performed according to a general method for forming a disposable dish by compression, and can also be performed according the manufacturing method and apparatus of the invention which will now be explained.

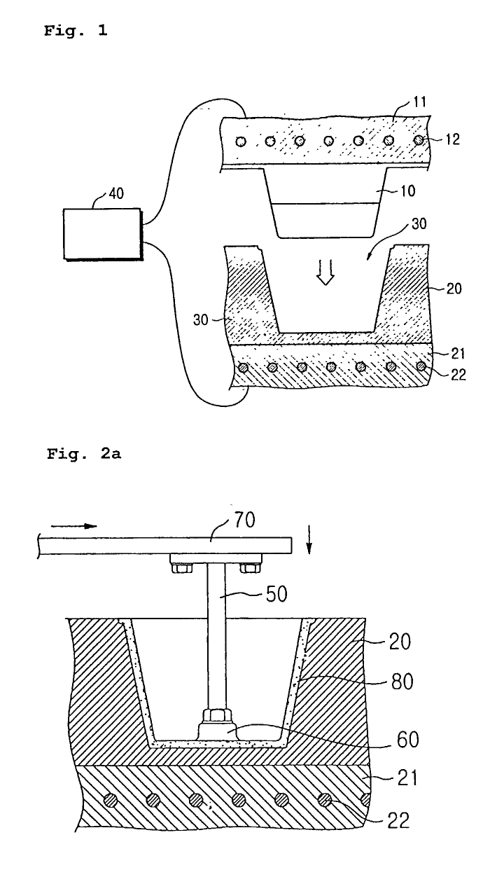

In the apparatus for manufacturing the naturally-degraded disposable dish as shown in FIG. 1, an upper mold 10 is installed on the bottom of a die 11 where a plurality of electric heating lines are filled, and a lower mold 20 has a space unit 30 for receiving the upper mold 10, and is installed on the top of a die 21 where a plurality of electric heating lines 22 are filled.

A controller adjusts a temperature of the upper/lower molds 10 and 20 by controlling electric power transmitted to the electric heating lines.

A transfer means automatically extracts a formation object 80 formed in the upper/lower molds 10 and 20, and automatically stacks the formation object.

Here, the transfer means includes: a holder 70 moved in a forward/backward direction and lifted by-the controller 40; and a cylinder 50 installed in the holder 70 for lifting a vacuum adsorbing plate 60 for vacuum-adsorbing the formation object 80.

The manufacturing method using the above-described apparatus will now be described.

In general, a formation process for injecting raw formation materials into the space unit of the lower mold, forming the raw formation materials of the space unit in a dish shape by pressing the upper mold toward the space unit of the lower mold and compressing the raw formation materials, removing a pressure of the upper mold, and lifting the upper mold has been publicly used.

In accordance with the present invention, the electric heating lines 12 and 22 are filled in the dies 11 and 21 of the upper/lower molds 10 and 20 in order to maintain the upper/lower molds 10 and 20 at a specific temperature. That is, the dish is formed by keeping the upper mold 10 at 140 to 145° C. and the lower mold 20 at 135 to 140° C. Here, the controller 40 controls the temperature.

The formation object 80 is extracted from the lower mold 20 by the automatic transfer means including the vacuum adsorbing plate 60.

Accordingly, the manufacturing apparatus of the invention maintains the upper mold 10 at 140 to 145° C. and the lower mold 20 at 135 to 140° C.

In this state, the raw formation materials of Example 1 are injected into the space unit 30 of the lower mold 20 and formed by the upper mold 10 for 9 to 10 seconds by first compression, and bubbles of the formation object 80 are evaporated for 2 to 4 seconds. Thereafter, the formation object is formed for 42 to 47 seconds by second compression, thereby manufacturing the dish. The dish is finally sterilized by using the ozone gas.

Since the upper/lower molds 10 and 20 are maintained at 140 to 145° C. and 135 to 140° C., the dish is naturally dried and basically sterilized.

When the formation object 80 is heated y the upper/lower molds 10 and 20, the bubbles are generated in the formation object 80. The surface of the formation object 80 is smoothened by removing the bubbles. Therefore, the bubbles of the formation object 80 are evaporated for 2 to 4 seconds.

In addition, the formation object 80 is automatically coated by the coating agent.

That is, the manufacturing method does not require the drying or coating step, to considerably reduce the manufacturing time of the dish.

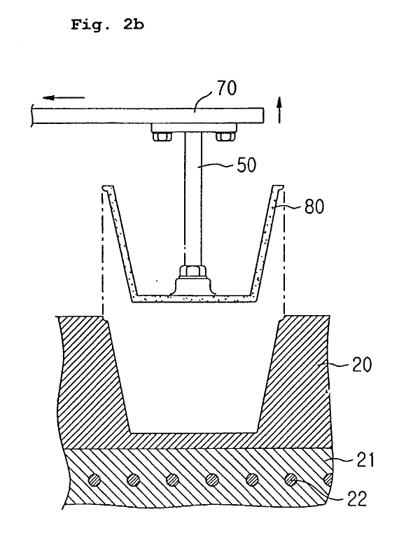

As illustrated in FIG. 2, the completed dish is extracted from the lower mold by the transfer means.

FIG. 2a is a view illustrating a state where the vacuum adsorbing plate is closely fixed to the dish so that the transfer means can lift the dish. Referring to FIG. 2a, when the dish is completed, the holder 70 is automatically moved in the forward direction and stopped at the upper portion of the lower mold 20 by the controller 40. When the holder 70 is lowered, a piston 51 of the cylinder 50 is also lowered to closely connect the vacuum adsorbing plate 60 adhered to the lower end of the piston 51 to the inside bottom of the formation object 80.

When the piston adsorbing plate 60 is closely connected to the inside bottom of the formation object 80, the air between the vacuum adsorbing plate 60 and the inside bottom of the formation object 80 is externally discharged. When the vacuum adsorbing plate 60 elastically returns to an original shape, an air ratio per unit volume is decreased due to an increased capacity, thereby remarkably reducing a pressure. Here, the external pressure of the vacuum adsorbing plate 60 is an air pressure much greater than the internal pressure thereof. Therefore, the vacuum adsorbing plate 60 is pressed in every direction, and thus is not separated.

FIG. 2b is a view illustrating a state where the dish is extracted from the lower mold by the transfer means. As depicted in FIG. 2b, the holder 70 is lifted by the controller 40 to extract the formation object 80 from the lower mold 20. Then, the holder 70 is moved in the backward direction to automatically stack the formation object 80 on a proper position.

The disposable dish manufactured according to the apparatus and method of the present invention obtains satisfactory results in temperature resistance and weight resistance performance measurements, as follows.

### Examination of Disposable Dish

1. Temperature Resistance Performance

### Measurement Conditions

1) The dish is filled with water of 80° C., and maintained for 30 minutes.

2) The dish is filled with water by ⅘, and heated at a high temperature for 3 minutes.

3) The dish is filled with water by ⅘, and left at a temperature below 20° C. for 2 hours.

### Measurement Results

The dish is not deformed, and water is not soaked into the dish or leaked from the dish.

2. Weight Resistance Performance

### Measurement Condition

3 kg of weight is put in the dish for 15 seconds.

### Measurement Result

A height of the dish is changed below 5%.

As discussed earlier, the present invention enhances strength of the dish by using the rice bran powder and corn starch, simplifies the manufacturing process and reduces the manufacturing time by mixing the raw formation materials at a time, and thus remarkably cuts down the manufacturing expenses.

Moreover, the structure of the apparatus for manufacturing the disposable dish is simplified to reduce the prime cost. The disposable dishes extracted from the apparatus are automatically stacked.

What is claimed is:

1. A method for manufacturing a naturally-degraded disposable dish comprising:
a first step for stirring 17.4 wt % of rice straw power, 4.3 wt % of rice bran powder, 61 wt % of coating agent and 17.3 wt % of corn starch to be uniformly mixed;
a second step for forming a dish by compressing the mixture; and
a third step for sterilizing the dish with an ozone gas.

2. The method according to claim 1, wherein the second step comprises: a step for forming the mixture for 9 to 10 seconds by first compression, evaporating bubbles of the dish for 2 to 4 seconds, and forming the dish for 42 to 47 seconds by second compression.

3. The method according to claim 1, wherein the method for manufacturing the naturally-degraded disposable dish uses 25 wt % of rice straw power, 5 wt % of rice bran powder, 20 wt % of coating agent and 50 wt % of corn starch.

4. The method according to claim 3, wherein the method forms the mixture for 10 to 15 seconds by first compression, evaporates bubbles of the dish for 2 seconds, and forms the dish for 25 to 30 seconds by second compression.

5. An apparatus for manufacturing a naturally-degraded disposable dish comprising:
an upper mold having a die where electric heating lines are filled;
a lower mold having a space unit for receiving the upper mold and a die where elect c heating lines are filled;
a controller for adjusting a temperature of the upper/lower molds by controlling electric power transmitted to the electric heating lines; and
a transfer means for automatically extracting a formation object from the upper/lower molds, and automatically stacking the formation object.

6. The apparatus according to claim 5, wherein the transfer means comprises: a holder moved in a forward/backward direction and lifted by the controller; and a cylinder installed in the holder for lifting a vacuum adsorbing plate for vacuum-adsorbing the formation object.
